(19) United States
(12) Patent Application Publication
(10) Pub. No.: US 2005/0235640 A1
(43) Pub. Date: Oct. 27, 2005

(54) Method and means of altering a vessel or structure in order to produce a force

(76) Inventor: William Armstrong, Hoonah, AK (US)

Correspondence Address: William Armstrong, POB 616, Hoonah, AK, 99829, US

(21) Appl. No.: 10/851,626

(22) Filed: May 22, 2004

Related U.S. Application Data
(60) Provisional application No. 60/564,882, filed on Apr. 23, 2004.

(51) Int. Cl. F03C 1/00

(52) U.S. Cl. 60/495

(57) ABSTRACT

A Method and Means of Altering a Vessel or Structure and in so doing a force is produced. Wherein the altering forces are Gravity, Buoyancy, or any man made or natural force. Wherein the net force produced is usable as work and is cheap, available and non polluting and in great need.

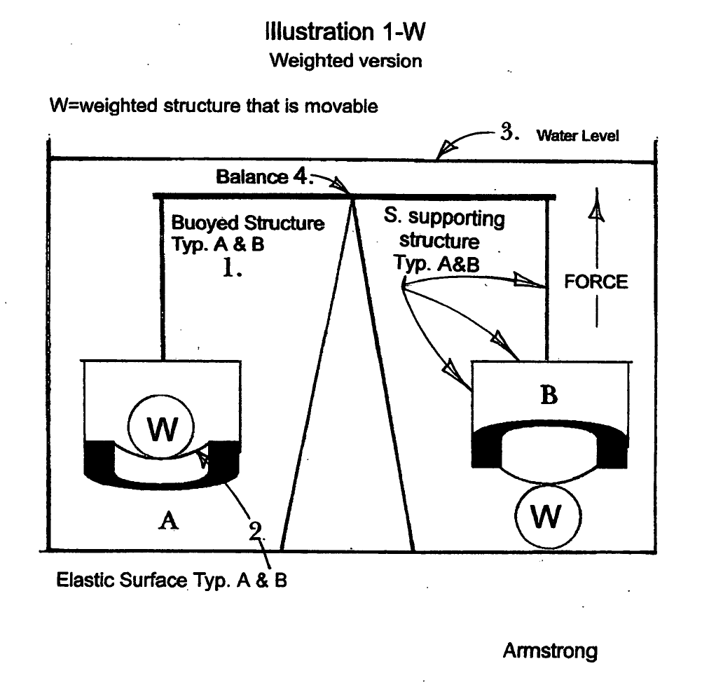

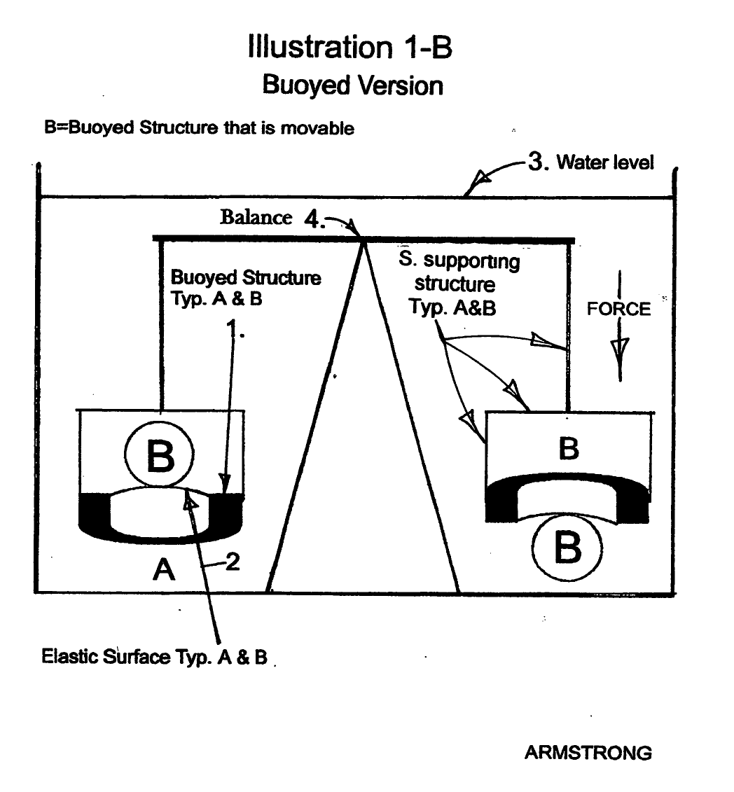

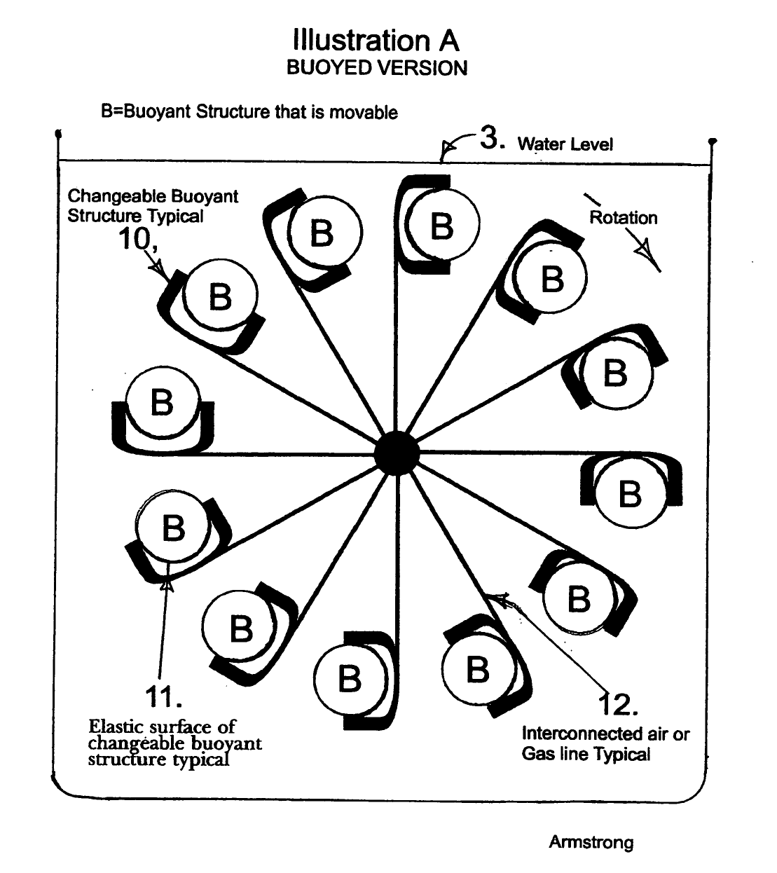

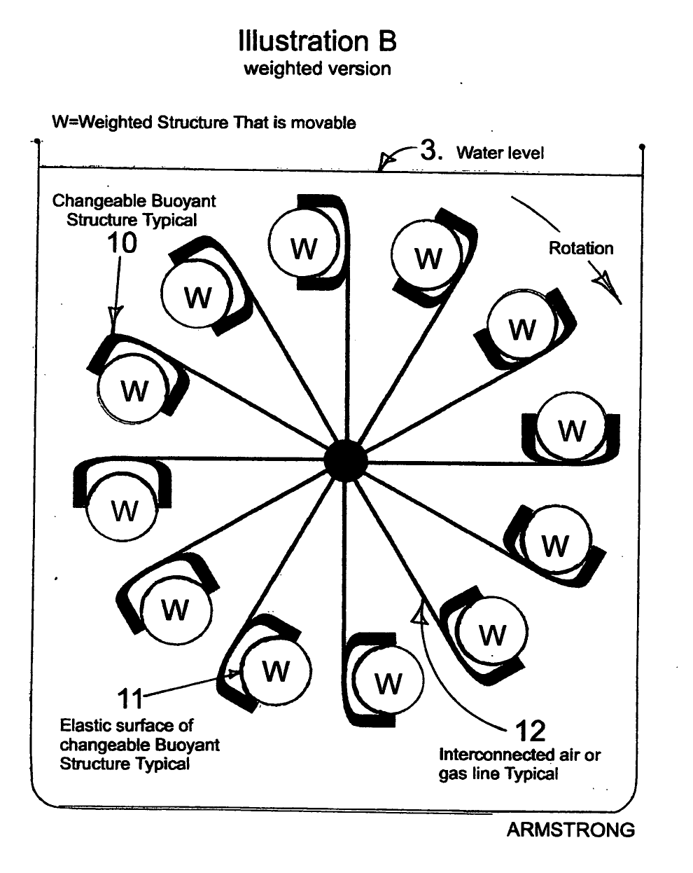

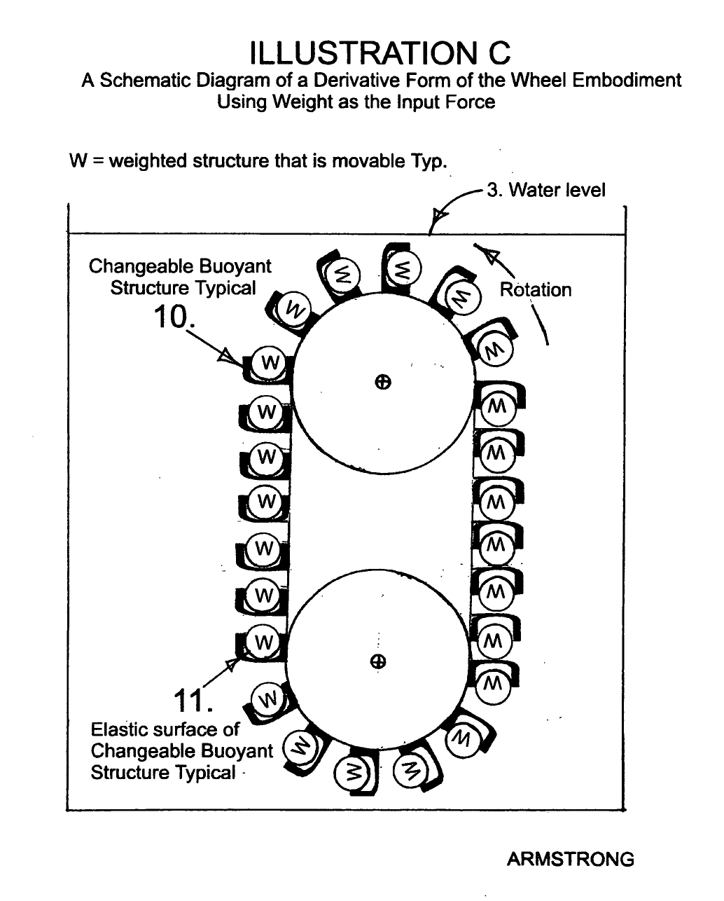

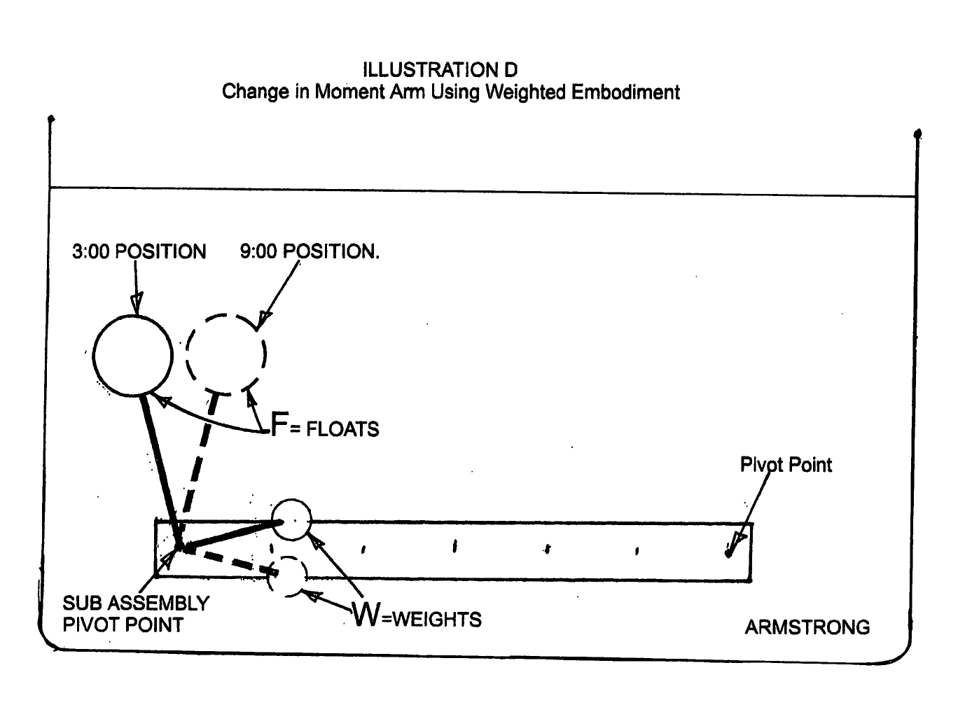

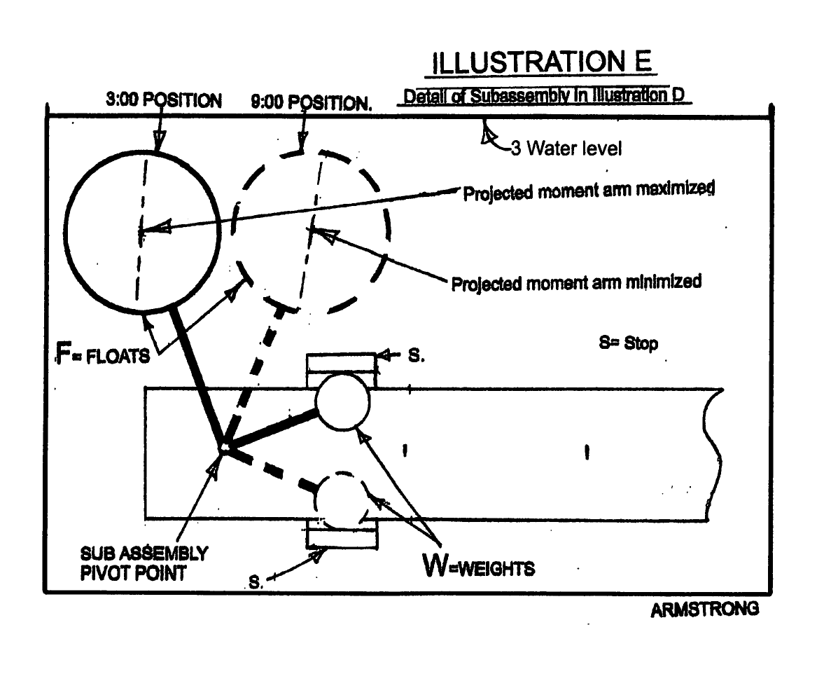

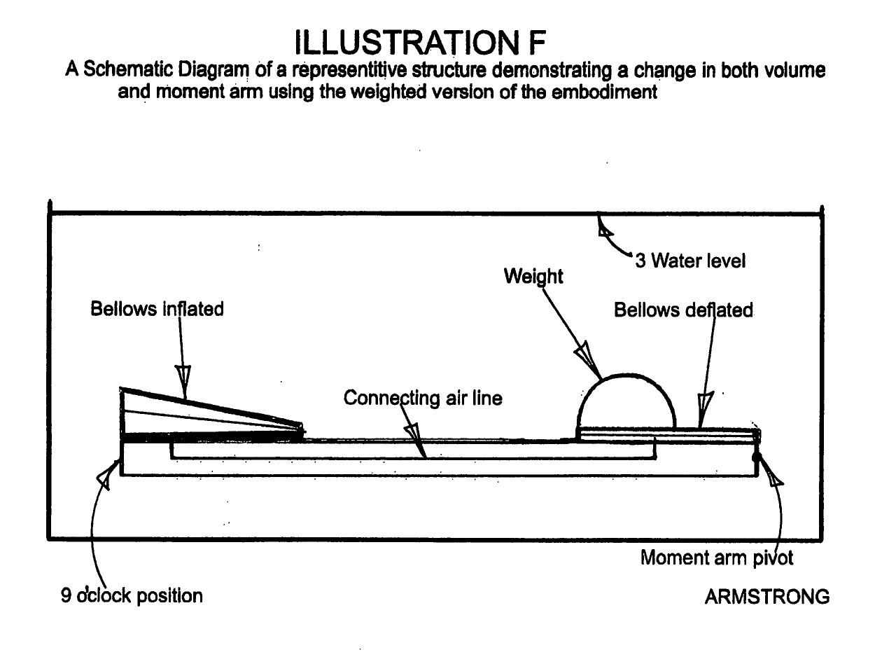

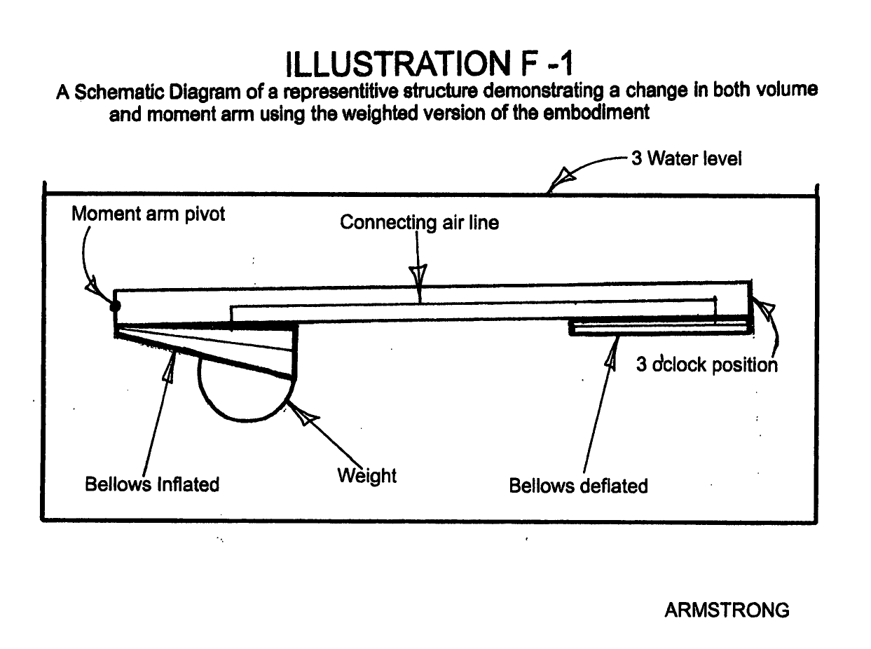

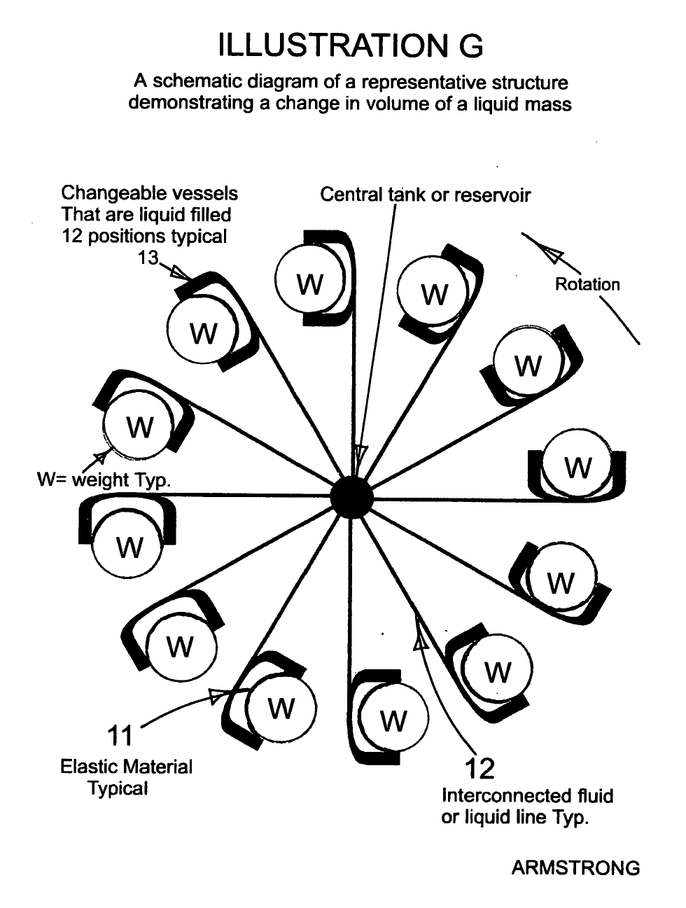

### BACKGROUND OF THE INVENTION

This invention pertains to methods and means of generating energy and more specifically to a Method and Means of Altering a Vessel or Structure in order to Produce a Force, that may be used for work.

It has been common practice in prior art to alter a vessel or structure in order to achieve a goal. Vessels and structures are altered to produce a change in buoyancy, volume, Weight, density, etc. Some examples of these altered vessels or structures are: Boats are altered in order to have specific desirable characteristics. A syringe is altered in order to fill it with liquid, and altered again in order to expel the same liquid. A balloon is altered when it is inflated and also when it is deflated.

In this respect, the Method and Means of Altering a Vessel or Structure in order to Produce a Force, substantially departs from conventional concepts and designs of prior art, and in so doing provides in the apparatus capable of altering vessels or structures in order to produce a force. Thus producing energy, that is useful non polluting and in great need.

### BRIEF SUMMERY OF THE INVENTION

In view of the foregoing, disadvantages inherent in the known types of energy producing cycles or devices now present and in prior art, the present invention provides a new and useful method and means of producing energy. To attain this, the invention essentially comprises an engine or devise, capable of altering a vessel or structure and in so doing produces a force. Such that the force may be harnessed for work.

It should be noted that in the context of the present description, the method and means to alter a vessel or structure, may take any form. The forms that can be used are: levers, wheels, belts, or any forms used in present or prior art. In so far as they do not depart from the scope of the invention.

There has thus been outline, rather broadly, the more important features of the of the invention in order that the detailed description thereof that follows may be better understood, and in order that the present contribution to the art may be better appreciated. There are, of course, additional features of the invention that will be described hereinafter and will form the subject matter of the claims annexed hereto.

In this respect, before explaining at least one embodiment of the invention, in detail, it is to be understood that the invention is not limited in its application to the details of construction and to arrangements of the components set forth in the following description or illustrated in the drawings. The invention is capable of other embodiments and being practiced and carried out in various ways. Also it is to be understood that the phraseology and terminology employed herein are for the purpose of description and should not be regarded as limiting.

As such those skilled in the art will appreciate that the conception, upon which this disclosure is based, may ready be utilized as a bases for the designing of other vessels, structures, methods and systems for carrying out the several purposes of the invention. It is important, therefore, that the claims be regarded as including equivalent constructions in so far as they do not depart from the scope of the invention. It is therefore an object of the present invention to provide a new and improved Method and Means of Altering a Vessel or Structure, in order to Produce a Force which has all the advantages of prior art and none of the disadvantages. Still yet another object of the present invention is to provide a new and improved, Method and Means of Altering a Vessel or Structure to Produce a Force, which provides in the apparatuses and methods of prior art some of the advantages thereof, while simultaneously overcoming some of the disadvantages normally associated therewith. It is another object of the present invention to provide a new and improved method and means of producing energy efficiently and with ease of manufacture and marketing. It is a further object of the present invention to provide an inexpensive and non polluting source of energy.

These together with other objects of the invention, along with various features of novelty which characterize the invention, are pointed out with particularity in the specifications, illustrations, embodiments and claims annexed to and forming the parts of this disclosure.

For a better understanding of the invention, its operating advantages and specific objects obtained by its use, reference should be made to the accompanying drawings and descriptive matter in which there are illustrated preferred embodiments of the invention.

### BRIEF DESCRIPTION OF DRAWINGS

The invention will be better understood and the objects of the same, as well as those set forth above will become apparent when consideration is given to the following detailed descriptions thereof. Such description makes reference to the annexed drawings wherein:

ILLUSTRATION 1-W Is a schematic diagram which represents a balance showing the inventive concept using weights as the altering force.

ILLUSTRATION 1-B is a schematic diagram which represents a balance showing the inventive concept using buoyancy as the altering force.

ILLUSTRATION A is a schematic diagram of a wheel structure according to the buoyant embodiment.

ILLUSTRATION B is a schematic diagram of a wheel structure according to the weighted embodiment.

ILLUSTRATION C is a schematic diagram of a derivative form of a wheel structure, showing the advantages of applying multiple vessels at the 3 and 9 o'clock positions.

ILLUSTRATION D is a schematic diagram of a representative structure, illustrating a change in moment arm, using a weighted embodiment.

ILLUSTRATION E is a schematic diagram of an enlarged detail of the moment arm change using the weighted embodiment.

ILLUSTRATION F is a schematic diagram of a representative structure demonstrating, a change in both volume and relative moment arm, using the weighted embodiment.

ILLUSTRATION F-1 is a schematic diagram of a representative structure demonstrating, a change in both volume and relative moment arm, using the weighted embodiment. This diagram represents the alternate position of the lever arm represented in the 3 o'clock position.

ILLUSTRATION G is a schematic diagram of a representative structure showing a change in volume of a liquid mass.

### DETAILED DESCRIPTION OF THE INVENTION

With reference now to the drawings, and in particular to illustration 1-W thereof, a new and improved Method and Means of Altering a Vessel or Structure in order to Produce a Force that may be used for work.

Illustration 1-W shows how the volume of a buoyant structure 1. is altered by the gravitational force of a weight W, acting on and attached to the elastic surface 2. As this diagram indicates the buoyant structure 1 is suspended from a balance in an upright position A and inverted in position B. This illustrates a volumetric change. As there is no longer a balance, a force is produced, of which there is no counteracting force. This is caused by the weight W., acting on the second structure B. in the opposite direction from A. And causing a volume increase, whereas A., has a volume decrease. The direction of the force is indicated by an arrow. Both structures A and B are constructed the same, with the same weight and elastic properties. In this illustration the only variable is the orientation of the structures to the gravitational force. Also the entire structure to include the balance is under water indicated by the number 3. (note structure indicated by the letter S. Is supporting the Buoyed structures and is not part of that structure.)

Illustration 1-B is buoyed version of the balance. All of the conditions previously described in illustration 1-W are the same, with the exception of W. now replaced with B=buoyed structure that is movable. This is to demonstrate that the volumetric change will occur, due to the effect of a buoyant force, changing the volumes of the effected structures. As indicated A., has an increase in volume and B., has a reduction in volume. Thus the balance has an indicated force and the balance has a movement in the direction of the arrow. Once again the only variable is the orientation of the structures.

Illustration A is a schematic diagram of a wheel structure according to the buoyant embodiment of the invention. In this illustration we have vessels positioned around a wheel, the construction of the vessels is similar to the previous illustrations. And the wheel is also under water. As in the previous illustrations, the principle is the same.

For the purpose of illustration I have indicated that the vessels are located at positions equivalent to a clock face 12 o'clock being the top and 6 o'clock being the bottom. As indicated all of the vessels 7 thru 11 o'clock will have an increase in volume, whereas, the vessels from 1 thru 5 o'clock will have a decrease in volume. I have discounted 6 and 12 as there is little change. As is indicated, a force is produced, causing the wheel to rotate in the indicated direction. Once again the only variable is the orientation of the vessels. We can only conclude that as the input force is buoyancy, is a constant and the wheel continues to rotate, we have a force that may be harnessed for work. (there is a interconnected air or gas line that aids the in volume change. This line can be for connection to each other as well as venting to a central chamber or atmosphere). This is important because the volume of the vessels change, will be greatly reduced without it.

Illustration B is a weighted version of the wheel embodiment and as with illustration A., the conditions are the same. So as in this illustration the input force is weights and a change in volumes will occur. As a result the wheel rotates and there is an indicated force, which is not counteracted. I have shortened this description so as to be brief and still understood.

Illustration C is a schematic diagram of a derivative form of the wheel embodiment using weight as the altering force. This illustrates the concept that the volume change is most significant at the 3 and 9 o'clock positions. Thus the maximum change can be multiplied by increasing the number of vessels using an ovoid form. It can be appreciated that many forms of embodiments can and will be used to increase the force obtained by the invention. So long as it does not depart from the scope of the invention.

Illustration D is a schematic diagram of a lever embodiment. This represents a new concept, not discussed in prior illustrations. In this illustration we see a lever which is pivoted on the right side. Attached on the left side is a pivoting subassembly at the 6 inch location of the lever. This subassembly has the ability, when inverted to change the position of the float F., using the force of the attached weight W. As the diagram indicates in this position representing the 9 o'clock position. The moment arm of the assembly is minimized, causing the buoyant moment arm to be minimized, with little or no change in the moment arm of the weight W. The dashed line portion of the subassembly is the indicated position of 9 o'clock. The solid line portion of the subassembly is the indicated position of 3 o'clock. We see that in the 3 o'clock position, the buoyant moment arm of the subassembly is maximized. Thus changing the buoyant moment arm of the assembly, with little or no change in the moment arm of the weight W. As we see this indicates that a gravitational force e.g.: the weight can alter the moment arm of a structure, without a volume change. From the information in this and the previous illustrations, we can see that a buoyant version of this embodiment will also work. (Note: Stops are required, so as not to allow the weight in the subassembly to travel beyond the indicated positions. The stops have been omitted from this illustration, but are included in illustration E., the detail of the subassembly).

Conversely we can make an assumption given the information in the prior illustrations, that a buoyant version of the invention, will also change the moment arm of the float.

Illustration E. is a schematic diagram of the detail of the subassembly, referenced in the previous illustration. This larger detail, helps to show the relationship between the weight and the float. As the assembly is inverted to the 3 o'clock position the weight moves and thus the attached float changes position relative to the assemblies pivot point. As there is little or no change in the weights moment arm and a sizable change in the floats moment arm, we have a force which is not counteracted in the embodiment. Note, that there are stops in this illustration referenced by the letter S. These are required to limit the travel of the weight as the position of the assembly is changed. This feature is important as the invention will not function without them.

Illustration F is a schematic diagram illustrating a change in both volume and relative moment arm. In the illustration we see a lever, with a bellows with a weight attached thereto. This bellows is attached to the lever at the 6 inch position from the pivot point of the same. There is a second bellows located at the 20 inch position. There is a tube or like structure connecting both bellows, which allows a gas or similar fluid material to pass between. As we can see the lever is at the 9 o'clock position, indicating the bellows at 6 inches is collapsed. Whereas the bellows at the 20 inch position is inflated, thus showing that the exertion of the weight has caused a change in both volume and relative moment arm. Thus we have a force that is not counteracted in the corresponding lever, in the 3 o'clock position, illustrated in F-1.

Illustration F-1 is a schematic diagram of the lever in illustration F., in the relative position of 3 o'clock. Thus we see from illustration, the bellows a the 6 inch position is now expanded, by the effort of the weight, with little or no change in the moment arm of the weight. Also we see that the bellows at the 20 inch position is now collapsed, showing a change in both volume and moment arm has occurred. Once again the only variable is the relative position of the vessel and structure.

Illustration G is a schematic diagram of a representative structure showing a change of volume of a liquid mass. As we see illustration G is similar to illustration B. There are differences that must be considered. 1. There is no water surrounding the structure. 2. The vessels are filled with a liquid, as opposed to a gas in illustration B. The alteration of the vessels are still caused by the weights. As we see looking at the relative position of the clock face. The 7-11 o'clock positions show an increase in volume. Whereas the positions representing 1-5 o'clock show a decrease in volume. This represents a significant change in the liquid masses position. An increase in positions 7-11 and a decrease in positions 1-5. The positions 6 and 12 have not been considered as there is little change at these positions. Thus an indicated force is produced with little or no change in the weights moment arms, and no counteracting force in the system. Also we see that by altering a vessels volume, we can effect relative buoyancy and weight of a fluid mass. This is achieved with little change in the altering force. The indicated rotation is counter clockwise.

It is imperative to note that the principles set forth herein above in each of the forgoing embodiments may be applied to any type of engine (rotary or other) in any type of application in any type of environment. Further uses of the foregoing invention include, but are not limited to, the harnessing of Heat, buoyancy, gravity, or any manmade or natural forces. As to the further manner of usage and operation of the present invention, the same should be apparent from the above descriptions. Accordingly no further discussion relating to the manner of usage will be provided. With respect to the above descriptions then, it is to be realized that the optimum dimensional relationships for the parts of the invention, to include variations in size, materials, shape, volume, density, form, function and manner of operation, assembly and use are deemed readily apparent and obvious to one skilled in the art, and all equivalent relationships to those illustrated in the drawings and described in the specifications are intended to be encompassed by the present invention. Therefore, the foregoing is considered as illustrative only of the principles of the invention. Further, since numerous modifications and changes will occur to those skilled in the art, it is no desired to limit the invention to the exact construction and operation shown and described, and accordingly, all suitable modifications and equivalents may be resorted to, falling within the scope of the invention:

Therefore the foregoing is to be considered as illustrative only of the principles of the invention.

1. A Method and Means of Altering a Vessel or Structure in order to Produce a Force, using a weighted form of altering force. As represented and described in the specifications and illustrations: W-1, B-1, A, B, C, D, E, F, F-1 and G. This method and means may be used stand alone or in conjunction with any method or means of present or prior art, as well as alternate embodiments of the present invention.

2. A Method and Means of Altering a Vessel or Structure in order to Produce a Force, using a buoyant form of altering force. As represented and described in the specifications and illustrations: W-1, B-1, A, B, C, D, E, F, F-1, and G. This method or means may be used stand alone or in conjunction with any method and means of present or prior art, as well as alternate embodiments of the present invention.

3. A Method and Means of Altering a Vessel or Structure in order to Produce a Force, using a gravitational force to move a fluid mass, thus producing a change in the fluid masses, gravitational force and moment arm. As represented and described in the specifications and illustrations: W-1, B-1, A, B, C, D, E, F, F-1, and more specifically G. This method and means may be used stand alone or in conjunction with any method or means of present or prior art, as well as alternate embodiments of the present invention.
